(19) United States
(12) Patent Application Publication
(10) Pub. No.: US 2011/0085356 A1
(43) Pub. Date: Apr. 14, 2011

(54) SWITCHING ELEMENT DRIVING CONTROL CIRCUIT AND SWITCHING POWER SUPPLY DEVICE

(75) Inventor: Naohiko MOROTA, Hyogo (JP)

(73) Assignee: PANASONIC CORPORATION, Osaka (JP)

(21) Appl. No.: 12/899,866

(22) Filed: Oct. 7, 2010

(30) Foreign Application Priority Data
Oct. 14, 2009 (JP) 2009-237790

(51) Int. Cl. H02M 3/335

(52) U.S. Cl. 363/21.04

(57) ABSTRACT

A switching element driving control circuit includes: a regulator circuit which generates a power supply voltage having an amplitude; a capacitor which smoothes the power supply voltage generated by the regulator circuit to remove a high frequency component; a circuit power supply line to which the smoothed power supply voltage is supplied; an oscillation circuit which generates a periodic signal according to an oscillation of the power supply voltage supplied from the circuit power supply line; a control circuit which generates a control signal for controlling the switching operation of the switching element, based on the periodic signal; and a driver circuit which supplies the switching element with the control signal.

### BACKGROUND OF THE INVENTION

(1) Field of the Invention

The present invention relates to a switching element driving control circuit used for a motor control, lighting, a switching power supply or the like, and to a switching power supply device.

(2) Description of the Related Art

A switching element driving control circuit is most commonly used in a switching power supply device. The switching power supply device converts an input power to a desired stabilized direct current (DC) power by using an AC-to-DC conversion device, a DC-to-DC conversion device, or the like. Generally, the switching power supply device converts an input power to a desired DC power by controlling turning on and off a switching element and repeating supplying and stopping a current that flows through a transformer or a coil.

As described, the switching power supply device continuously and periodically repeats turning on and off the switching element.

A problem of the switching power supply device is a phenomenon where a switching noise causes malfunction of electronic devices in the vicinity of the switching power supply device. Such a phenomenon is referred to as an Electro-Magnetic Interference (EMI).

As a countermeasure to the EMI, U.S. Pat. No. 6,107,851 discloses a technique for suppressing harmonic by modulating a basic frequency of a switching power supply device using a Pulse Width Modulation (PWM) control to spread spectrum of the switching noise.

Further, the EMI problem is not limited to the PWM control where the switching power supply device operates at a low frequency. In a Pulse Frequency Modulation (PFM) control in which frequencies vary depending on a load and a quasi-resonant control, too, frequencies are stabilized when the load is stable. This may cause a similar switching noise. Further, also in the quasi-resonant control where an oscillator is not included, in the case where an input voltage is high and the load is stable, a similar problem occurs.

In view of the problem, Japanese Patent Application Publication No. 2009-142085 discloses a technique for modulating a switching frequency in the quasi-resonant control by adding a modulation component to a current peak of the switching element.

Further, Japanese Patent Application Publication No. 2008-312359 discloses a method for modulating a switching frequency in the PFM control where frequencies vary depending on the load or a secondary side on-duty control in accordance with the respective control.

Such techniques in which a low-frequency modulation component is added to a switching frequency is referred to as a frequency jitter.

### SUMMARY OF THE INVENTION

However, the conventional switching power supply devices need to include a low-frequency oscillation circuit in a control circuit of a switching element to modulate the oscillating frequency of the switching element. There are various types of oscillation circuits which typically require capacitors. In the case of the low-frequency oscillation circuit, the capacitance value needs to be increased. In the case where the capacitor and a control circuit of the switching element are formed on a single semiconductor board, they occupy a large area on the semiconductor board. Such a large-area capacitor leads to an increase in a chip area, which prevents reduction in cost.

The present invention has been conceived in view of the problems, and has an object to provide a technique in which a modulation component is added to a switching frequency of a switching element by effectively using an existing circuit without adding a low-frequency oscillation circuit.

In order to solve the problems, a switching element driving control circuit according to an aspect of the present invention includes: a regulator circuit which generates a power supply voltage having an amplitude; a capacitor which smoothes the power supply voltage generated by the regulator circuit to remove a high frequency component; a circuit power supply line to which the smoothed power supply voltage is supplied; an oscillation circuit which generates a periodic signal according to an oscillation of the power supply voltage supplied from the circuit power supply line; a control circuit which generates a control signal for controlling the switching operation of the switching element, based on the periodic signal; and a driver circuit which supplies the switching element with the control signal.

With the configuration, the regulator circuit generates a power supply voltage having an amplitude in an electric potential range where all circuits connected to the circuit power supply line can operate normally; and thus, the power supply voltage oscillates at a low frequency by a circuit consumption current and the capacitor connected to the circuit power supply. By adding the oscillation, as a modulation component, to the switching frequency of the switching element of the PWM control or the PFM control, noises of the switching element driving control circuit can be reduced without adding a low-frequency oscillation circuit.

Further, in order to solve the problems, a switching element driving control circuit according to an aspect of the present invention is includes: a regulator circuit which generates a power supply voltage having an amplitude; a capacitor which smoothes the power supply voltage generated by the regulator circuit to remove a high frequency component; a circuit power supply line to which the smoothed power supply voltage is supplied;

a secondary current on-period detection circuit which detects a first period that is a period from when the switching element turns off until when a secondary current that flows through the secondary winding finishes flowing; a secondary current on-duty control circuit which generates a clock signal according to the amplitude of the power supply voltage supplied from the circuit power supply line such that an on-duty ratio of the first period to a third period is maintained, the clock signal turning on the switching element, the third period including the first period and a second period that is a period during which the secondary current does not flow; a control circuit which generates a control signal for controlling the switching operation of the switching element, based on the clock signal; and a driver circuit which supplies the switching element with the control signal.

With the configuration, the regulator circuit generates a power supply voltage having an amplitude in an electric potential range where all circuits connected to the circuit power supply line can operate normally; and thus, the power supply voltage oscillates at a low frequency by a circuit consumption current and the capacitor connected to the circuit power supply. By adding the oscillation, as a modulation component, to the switching frequency of the switching element of the secondary current on-duty control method, noises of the switching element driving control circuit can be reduced without adding a low-frequency oscillation circuit.

Further, in order to solve the problems, a switching element driving control circuit according to an aspect of the present invention includes: a regulator circuit which generates a power supply voltage having an amplitude; a capacitor which smoothes the power supply voltage generated by the regulator circuit to remove a high frequency component; a circuit power supply line to which the smoothed power supply voltage is supplied; a secondary current on-period detection circuit which detects a first period that is a period from when the switching element turns off until when a secondary current that flows through the secondary winding finishes flowing; a turn-on control circuit which generates an on-signal for turning on the switching element, according to an output of the secondary current on-period detection circuit; a control circuit which includes a drain current control circuit that generates an off-signal according to the amplitude of the power supply voltage supplied from the circuit power supply line when a current that flows through the switching element reaches a predetermined current peak level, the off-signal turning off the switching element, the control circuit generating a control signal for controlling the switching operation of the switching element, based on the on-signal and the off-signal; and a driver circuit which supplies the switching element with the control signal.

With the configuration, the regulator circuit generates a power supply voltage having an amplitude in an electric potential range where all circuits connected to the circuit power supply line can operate normally; and thus, the power supply voltage oscillates at a low frequency by a circuit consumption current and the capacitor connected to the circuit power supply. By adding the oscillation, as a modulation component, to the switching frequency of the switching element of the quasi-resonant control method, noises of the switching element driving control circuit can be reduced without adding a low-frequency oscillation circuit.

Further, the regulator circuit may be a hysteresis control regulator circuit which controls an output voltage based on a first threshold and a second threshold lower than the first threshold.

With the configuration, stable power supply voltage can be generated in an electric potential range that is previously set, by using a hysteresis control regulator circuit as a regulator circuit.

Further, it may be that at least the regulator circuit, the control circuit, and the oscillation circuit are incorporated into a single package.

Further, it may be that at least the regulator circuit, the control circuit, the secondary current on-duty control circuit, and the secondary current on-period detection circuit are incorporated into a signal package.

Further, it may be that at least the regulator circuit, the control circuit, and the secondary current on-duty control circuit are incorporated into a single package.

With the configuration, respective circuits, such as a control circuit of the switching element driving control circuit, are incorporated into a single package. Thus, circuit configuration of the switching element driving control circuit can be simplified by not separately connecting the respective circuits to the circuit power supply line, but by connecting the package to the circuit power supply line.

Further, it may be that the switching element driving control circuit further includes an external terminal which allows the capacitor to be adjusted.

With the configuration, the switching element driving control circuit includes an external terminal; and thus, the modulating period of the switching frequency of the switching element can be externally adjusted by adjusting the capacitor for stabilizing the power supply voltage from the external terminal to externally set the modulation component of the low frequency of the power supply voltage.

Further, in order to solve the problems, it may be that a switching power supply device according to an aspect of the present invention includes: the switching element driving control circuit; and a rectifying and smoothing circuit which converts a voltage generated at the secondary winding by the switching operation of the switching element into a DC voltage.

With the configuration, the regulator circuit of the switching element driving control circuit generates a power supply voltage having an amplitude in an electric potential range where all circuits connected to the circuit power supply line can operate normally; and thus, the power supply voltage oscillates at a low frequency by a circuit consumption current and a capacitor connected to the circuit power supply. By adding the oscillation, as a modulation component, to the switching frequency of the switching power supply device of various types of control methods including the PWM control, PFM control, secondary current on-duty control, and quasi-resonant control, noises of the switching power supply device can be reduced without adding a low-frequency oscillation circuit and increasing the size of the switching power supply device.

Further, in order to solve the problems, it may be that a switching power supply device according to an aspect of the present invention includes the switching element driving control circuit; a rectifying and smoothing circuit which converts a voltage generated at the secondary winding by the switching operation of the switching element into a DC voltage; and an output voltage detection circuit which detects the DC voltage and supplies the control circuit with a feedback signal generated according to a change in the detected DC current, wherein the drain current control circuit generates the off-signal for turning off the switching element when the current that flows through the switching element reaches the current peak level set according to the feedback signal.

With the configuration, the DC voltage that is an output voltage is detected by the output voltage detection circuit, and the feedback of the detected DC voltage is provided to the drain current control circuit. Thus, it is possible to further stabilize the switching operation of the switching element and the power supply voltage, and to reduce noises of the switching power supply device by adding a modulation component to the switching frequency of the switching element without adding a low-frequency oscillation circuit and increasing the size of the switching power supply device.

The switching element driving control circuit and the switching power supply circuit according to an aspect of the present invention provide a technique for applying a modulation component to the switching frequency of the switching element by effectively using an existing circuit without adding a low-frequency oscillation circuit.

### FURTHER INFORMATION ABOUT TECHNICAL BACKGROUND TO THIS APPLICATION

The disclosure of Japanese Patent Application No. 2009-237790 filed on Oct. 14, 2009 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram of a switching element driving control circuit and a switching power supply device according to Embodiment 1 of the present invention;

FIG. 2 is a diagram showing an operation of a circuit power supply voltage of the switching element driving control circuit and the switching power supply device according to Embodiment 1 of the present invention;

FIG. 3 is a diagram showing a first configuration example of an oscillation circuit of the switching element driving control circuit according to Embodiment 1 of the present invention;

FIG. 4 is a diagram showing a configuration of a control circuit of the switching element driving control circuit according to Embodiment 1 of the present invention;

FIG. 5 is a diagram showing a second configuration example of the oscillation circuit of the switching element driving control circuit according to a variation of Embodiment 1 of the present invention;

FIG. 6 is a configuration diagram showing a switching element driving control circuit and a switching power supply device according to Embodiment 2 of the present invention;

FIG. 7 is a diagram showing a configuration of a secondary current on-period detection circuit of the switching element driving control circuit according to Embodiment 2 of the present invention;

FIG. 8 is a diagram showing a first configuration example of a secondary current on-duty control circuit of the switching element driving control circuit according to Embodiment 2 of the present invention;

FIG. 9 is a diagram showing a configuration of a control circuit of the switching element driving control circuit according to Embodiment 2 of the present invention;

FIG. 10 is a diagram showing a second configuration example of the secondary current on-duty control circuit of the switching element driving control circuit according to a variation of Embodiment 2 of the present invention;

FIG. 11 is a configuration diagram showing a switching element driving control circuit and a switching power supply device according to Embodiment 3 of the present invention;

FIG. 12 is a diagram showing a first configuration example of a control circuit of the switching element driving control circuit according to Embodiment 3 of the present invention;

FIG. 13 is a diagram showing a configuration of a feedback signal control circuit of the switching element driving control circuit according to Embodiment 3 of the present invention; and

FIG. 14 is a diagram showing a secondary configuration example of a control circuit of the switching element driving control circuit according to a variation of Embodiment 3 of the present invention.

### DESCRIPTION OF THE PREFERRED EMBODIMENT(S)

Hereinafter, embodiments of the present invention are described. The embodiments of the present invention are described with reference to the accompanying drawings; however, it is for illustrative purpose only and is not intended to limit the scope of the present invention.

### Embodiment 1

A switching element driving control circuit according to Embodiment 1 includes: a regulator circuit which generates a power supply voltage having an amplitude; a capacitor which smoothes the power supply voltage generated by the regulator to remove a high frequency component; a circuit power supply line to which the smoothed power supply voltage is supplied; an oscillation circuit which generates a periodic signal according to the oscillation of the power supply voltage supplied from the circuit power supply line; a control circuit which generates a control signal for controlling the switching operation of a switching element, based on the periodic signal; and a driver circuit which supplies the switching element with the control signal.

With the configuration, the regulator circuit generates a power supply voltage in an electric potential range where all circuits connected to the circuit power supply line can operate normally; and thus, the power supply voltage oscillates at a low frequency by a circuit consumption current and the capacitor connected to the circuit power supply. By adding the oscillation, as a modulation component, to the switching frequency of the switching element of the various types of control methods including the PWM control and the PFM control, noises of the switching element driving control circuit can be reduced by adding the modulation component to the switching frequency of the switching element without adding a low-frequency oscillation circuit.

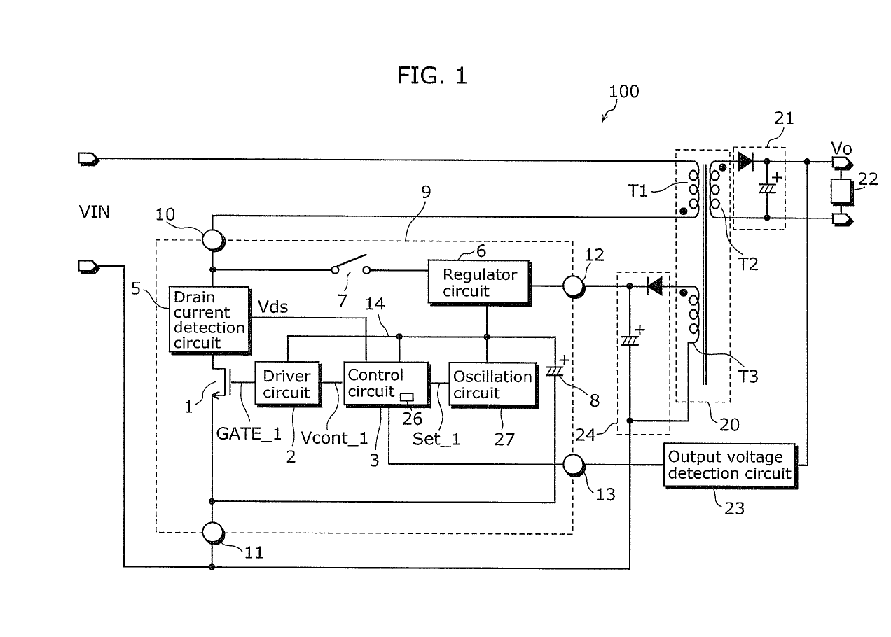

FIG. 1 shows a switching power supply device 100 including a switching element driving control circuit 9 according to Embodiment 1 of the present invention. In the present embodiment, an example of the switching power supply device of the PWM control method is described.

In FIG. 1, the switching power supply device 100 includes: the switching element driving control circuit 9; a transformer 20; a rectifying and smoothing circuit 21; a load 22; an output voltage detection circuit 23; and a rectifying and smoothing circuit 24.

The transformer 20 includes a primary winding T1; a secondary winding T2; and a supplementary winding T3. The switching element driving control circuit 9 includes: a switching element 1 made of a power MOSFET; a driver circuit 2; a control circuit 3; a drain current detection circuit 5; a regulator circuit 6; a starting current supplying switch 7; a capacitor 8; a circuit power supply line 14; and an oscillation circuit 27. The switching element driving control circuit 9 includes, as external terminals, a DRAIN terminal 10 for supplying a drain current to a switching element 1; a SOURCE terminal 11 for supplying a source current to the switching element 1; a VCC terminal 12 for receiving a high voltage supplied to the regulator circuit 6; an FB terminal 13 for providing a feedback voltage to the control circuit 3.

The primary winding T1 of the transformer 20 is connected to the DRAIN terminal of the switching element driving control circuit 9. The secondary winding T2 of the transformer 20 is connected to the rectifying and smoothing circuit 21. The voltage generated at the secondary winding T2 of the transformer 20 by the switching operation of the switching element 1 is supplied to the load 22 as a stabilized DC voltage. Further, the output of the rectifying and smoothing circuit 21 is connected to the output voltage detection circuit 23 which detects the output voltage output from the rectifying and smoothing circuit 21 as an output signal for feedback. The output voltage detection circuit 23 is further connected to an FB terminal 13 of the switching element driving control circuit 9.

The supplementary winding T3 of the transformer is connected to the rectifying and smoothing circuit 24, and supplies a voltage as a high voltage input power supply to the VCC terminal 12 of the switching element driving control circuit 9.

In the switching element driving control circuit 9, the switching element 1 is connected between the DRAIN terminal 10 and the SOURCE terminal 11, and repeats supplying and stopping a current which flows through the primary winding T1, by the switching operation. Further, the drain current detection circuit 5, provided between the switching element 1 and the DRAIN terminal 10, detects an element current which flows through the switching element 1, and outputs an element current detection signal Vds to the control circuit 3.

The oscillation circuit 27 generates an output signal Set_1 that is a periodic signal which will serve as a turn-on control pulse of the switching element 1, and supplies the control circuit 3 with the generated output signal Set_1.

The control circuit 3 is connected to the oscillation circuit 27, the drain current detection circuit 5, and the FB terminal 13, and generates a control signal Vcont_1 for controlling the switching operation of the switching element 1.

The driver circuit 2 is connected to a gate terminal that is a control terminal of the switching element 1. The driver circuit 2 converts the control signal Vcont_1 of the control circuit 3 to an output signal GATE_1 that has a current capability suited for the size of the switching element 1, and supplies the switching element 1 with the output signal GATE_1.

The regulator circuit 6 is connected to the VCC terminal 12 that is a high voltage input terminal which receives a voltage generated at the supplementary winding T3 of the transformer 20. The regulator circuit 6 generates a power supply voltage having an amplitude lower than the voltage of the supplementary winding T3, based on the voltage of the supplementary winding T3 of the transformer 20, and supplies the circuit power supply line 14 with the generated power supply voltage. Further, the starting current supplying switch 7 connects the regulator 6 and the DRAIN terminal 10, which is a high voltage terminal connected to the primary winding of the transformer 20, at the time of start-up, or when the voltage of the VCC terminal 12 is lower than the voltage of the circuit power supply line 14. Further, the capacitor 8 is provided for stabilizing the power supply voltage generated by the regulator circuit 6, that is, for smoothing the amplitude of the power supply voltage so that a high frequency component is removed. The smoothed power supply voltage is supplied to the circuit power supply line 14.

In such a manner, it is possible that the regulator circuit 6 stably generates the power supply voltage even in the case where the voltage of the supplementary winding T3 is lower than the power supply voltage of the circuit power supply line 14.

Further, the circuit power supply line 14 is connected to respective circuits mounted on the switching element driving control circuit 9, such as the driver circuit 2, the control circuit 3, and the oscillation circuit 27. The respective circuits are driven by the power supply voltage supplied from the circuit power supply line 14.

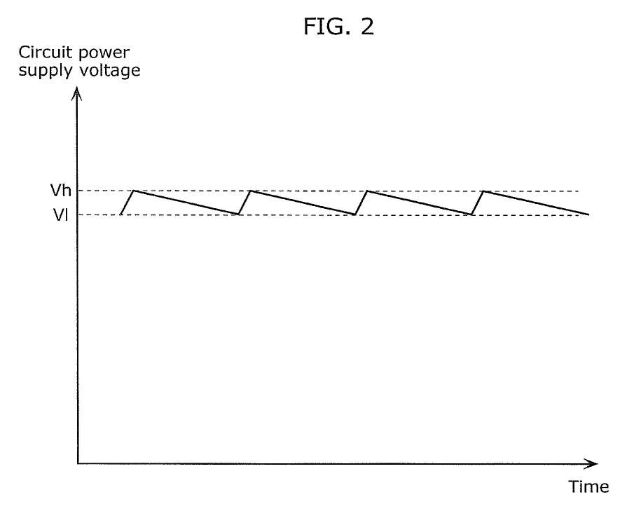

FIG. 2 is a diagram showing a power supply voltage generated by the regulator circuit 6. In general, the regulator circuit 6 generates an output signal having a constant voltage. However, in the present embodiment, the regulator circuit 6 generates an output signal which oscillates within an electric potential range which is previously set. The potential range is set within a rage where all the circuits connected to the circuit power supply line 14 can operate normally. The regulator circuit 6 according to the present embodiment is, for example, a hysteresis control regulator. The hysteresis control regulator has a first threshold voltage Vh and a second threshold voltage Vl that is lower in potential than the first threshold voltage Vh, and regulates the output voltage between the two potentials. More specifically, as shown in FIG. 2, the power supply voltage thus generated has a low-frequency oscillation waveform (triangular wave) which repeats charging and discharging between the threshold voltage Vh and the threshold voltage Vl according to the consumption current of the respective circuits included in the switching element driving control circuit 9 and the high input voltage from the VCC terminal 12 or the DRAIN terminal 10.

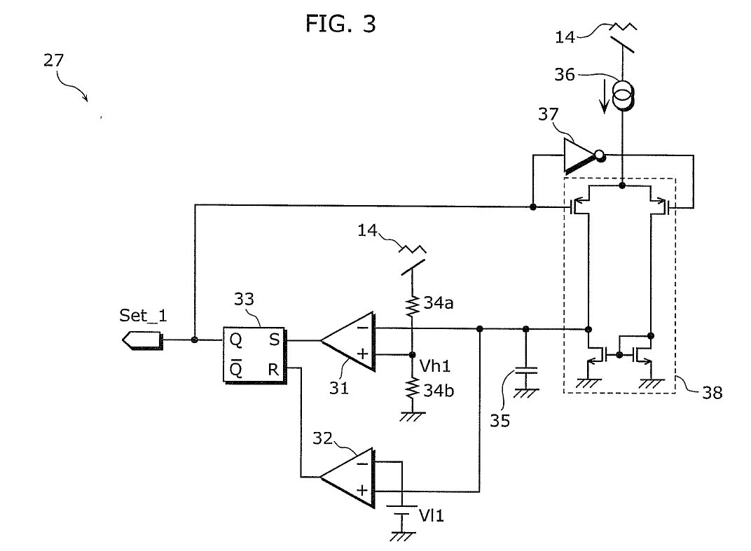

FIG. 3 is a first configuration example of the oscillation circuit 27 of the switching element driving control circuit 9 according to Embodiment 1 of the present invention.

The oscillation circuit 27 includes comparators 31 and 32, an RS latch circuit 33, series resistances 34a and 34b, a capacitor 35, an inverter 37, a constant current source 36, and a differential amplifier circuit 38. The oscillation circuit 27 generates the output signal Set_1 that is a periodic signal according to the oscillation of the power supply voltage supplied from the circuit power supply line 14.

The capacitor 35 is connected to the output of the differential amplifier circuit 38. The electric potential of the capacitor 35 is compared with the respective thresholds by the comparators 31 and 32.

The outputs of the comparators 31 and 32 are respectively connected to the set input S and the reset input R of the RS latch circuit 33. The differential amplifier circuit 38 is driven by receiving the voltage output from the output Q of the RS latch circuit 33, and the voltage output from the output Q of the RS latch circuit 33 and inverted by the inverter 37.

Further, the differential amplifier circuit 38 is connected to the constant current source 36 which receives the power supply voltage from the circuit power supply line 14. The electric potential of the capacitor 35 forms a low-frequency oscillation waveform (triangular wave) by the current of the constant current source 36 being charged to and discharged from the capacitor 35 via the differential amplifier circuit 38.

The upper limit of the triangular wave is controlled by the threshold voltage Vh1 of the comparator 31, and the lower limit of the triangular wave is controlled by the threshold voltage Vl1 of the comparator 32, making the output of the RS latch circuit 33 a clock signal.

Here, the threshold voltage Vh1 of the comparator 31 is generated by resistance dividing the power supply voltage of the circuit power supply line 14 using the series resistances 34a and 34b.

Since the power supply voltage of the circuit power supply line 14 oscillates at a law frequency due to the regulator circuit 6 as described above, the threshold voltage Vh1 also varies depending on the oscillation of the power supply voltage of the circuit power supply line 14.

As a result, the charging and discharging period of the capacitor 35 varies depending on the amplitude of the power supply voltage supplied from the circuit power supply line 14; and thus, the output signal Set_1 that is a periodic signal output by the oscillation circuit 27 has a low-frequency modulation component which oscillates between the threshold voltage Vh1 and the threshold voltage Vl1.

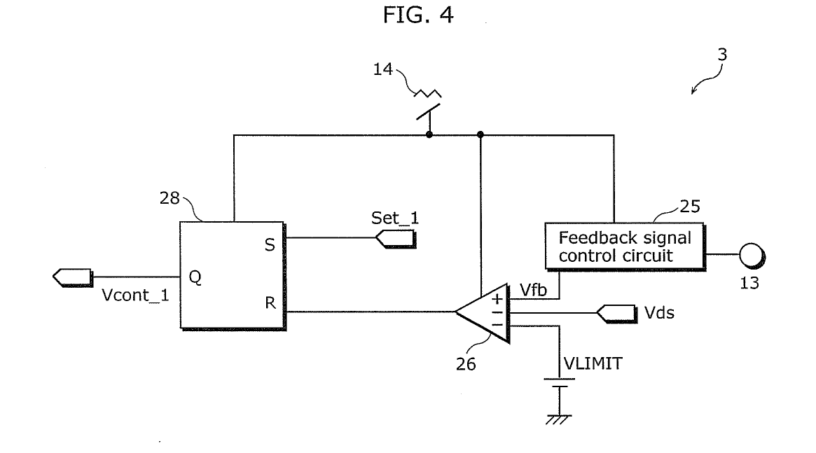

FIG. 4 is a diagram showing the control circuit 3 of the switching element driving control circuit 9 according to Embodiment 1 of the present invention.

In FIG. 4, the control circuit 3 includes: a feedback signal control circuit 25; a drain current control circuit 26; and an RS latch circuit 28. The respective circuits 25, 26 and 28 are connected to the circuit power supply line 14.

The feedback signal control circuit 25 is connected to the FB terminal 13. The feedback signal control circuit 25 amplifies the feedback output signal that is output from the output voltage detection circuit 23 and provided to the FB terminal 13, filters the amplified signal, outputs the feedback control signal Vfb, and inputs the resultant to the drain current control circuit 26.

Further, the drain current control circuit 26 receives, as inputs, an element current detection signal Vds output from the drain current detection circuit 5 and a reference voltage VLIMIT, and outputs a turn-off control pulse of the switching element 1 when the element current detection signal Vds is equal to the reference voltage VLIMIT or the feedback control signal Vfb. More specifically, the drain current control circuit 26 generates a signal for turning off the switching element 1, when the current that flows through the switching element 1 reaches the current peak level of the switching element that is set according to the feedback control signal Vfb. Further, the drain current control circuit 26 is connected to the circuit power supply line 14, and modulates the current peak level of the switching element 1 according to the power supply voltage.

The RS latch circuit 28 receives the output signal Set_1 that is a periodic signal generated by the oscillation circuit 27 through the set input S, receives the output of the drain current control circuit 26 through the reset input R, and outputs the control signal Vcont_1 through the output Q.

After that, the control signal Vcont_1 output from the control circuit 3 is input to the driver circuit 2. The driver circuit 2 converts the control signal Vcont_1 to the output signal GATE_1 that has a current capability suited for the size of the switching element 1, and inputs the output signal GATE_1 to the control terminal (gate terminal) of the switching element 1. The voltage generated at the secondary winding T2 of the transformer 20 by the switching operation of the switching element 1 is supplied to the load 22 as a stabilized DC voltage via the rectifying and smoothing circuit 21.

Note that the present invention is not limited to the switching power supply device of the PWM control method. The present invention can be applied to the switching power supply device employing any other methods including a PFM control method.

### Variation of Embodiment 1

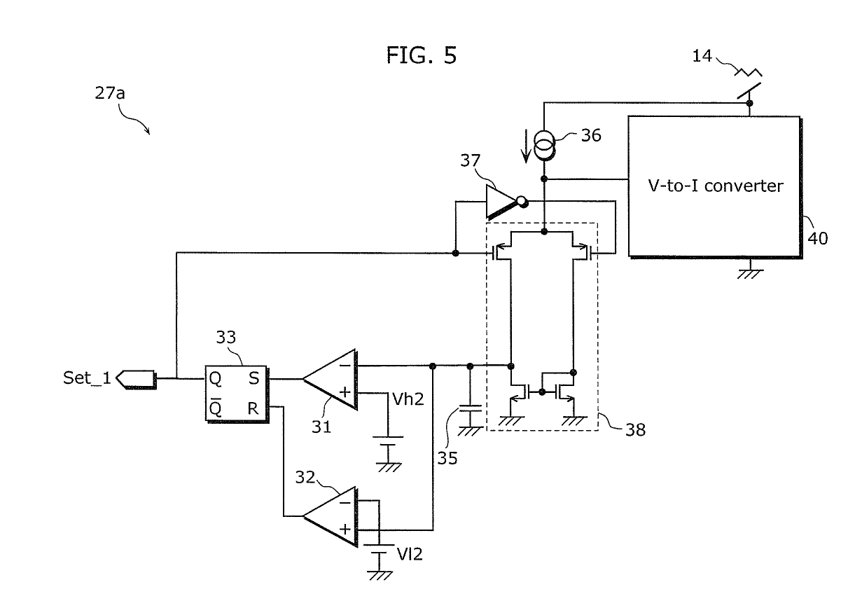

FIG. 5 shows a second configuration example of the oscillation circuit of the switching element driving control circuit according to a variation of the Embodiment 1 of the present invention. An oscillation circuit 27a according to the present variation greatly differs from the oscillation circuit 27 in that the oscillation circuit 27a includes a V-to-I convertor 40.

As shown in FIG. 5, the oscillation circuit 27a includes: comparators 31 and 32; the RS latch circuit 33; the capacitor 35; the inverter 37; the constant current source 36; the differential amplifier circuit 38; and the V-to-I convertor 40 which converts the power supply voltage of the circuit power supply line 14 to a current. As shown in the oscillation circuit 27 of FIG. 3, the comparator 31 may include the series resistances 34a and 34b.

The differential amplifier circuit 38 is connected to the constant current source 36 which receives the power supply voltage from the circuit power supply line 14, and to the V-to-I convertor 40 provided in parallel with the constant current source 36. When the currents of the constant current source 36 and the V-to-I convertor 40 are charged and discharged to and from the capacitor 35 via the differential amplifier circuit 38, the potential of the capacitor 35 forms a low-frequency oscillation waveform (triangular wave) which oscillates at a voltage between the threshold voltage Vh2 and the threshold voltage Vl2.

Accordingly, the charging and discharging current of the capacitor 35 includes not only the current of the constant current source 36, but also the current of the V-to-I convertor 40 which varies in proportion to the power supply voltage. Thus, frequencies further vary depending on the variation of the power supply voltage. As a result, the output signal Set_1 that is a turn-on control pulse output from the oscillation circuit 27a includes a low-frequency modulation component.

In Embodiment 1, for example, part of the control circuit 3 and the regulator circuit 6 of the switching element driving control circuit 9 may be incorporated in a single package. In this case, as shown in FIG. 1, the capacitor 8 for smoothing the power supply voltage can be externally adjusted through the VCC terminal 12 that is an external terminal provided to the switching element driving control circuit 9. Thus, the modulation component of the periodic signal can be externally set via the capacitor 8.

### Embodiment 2

Next, a switching power supply device 200 which includes a switching element driving control circuit 9a according to Embodiment 2 of the present invention is described. In the present embodiment, an example of a switching power supply device of a secondary current on-duty control method is described.

The present embodiment differs from Embodiment 1 in that the switching element driving control circuit 9a includes a secondary current on-period detection circuit 44 and a secondary current on-duty control circuit 45. Further, the present embodiment differs from Embodiment 1 in that the configuration of the control circuit 3a is different and that the output voltage detection circuit 23 and the oscillation circuit 27 are not included.

With the configuration, by adding, as a modulation component, the oscillation of the power supply voltage generated by the regulator circuit 6 to the switching frequency of the switching power supply device 200 of the secondary current on-duty control method, noises of the switching element driving control circuit 9a can be reduced without adding a low-frequency oscillation circuit.

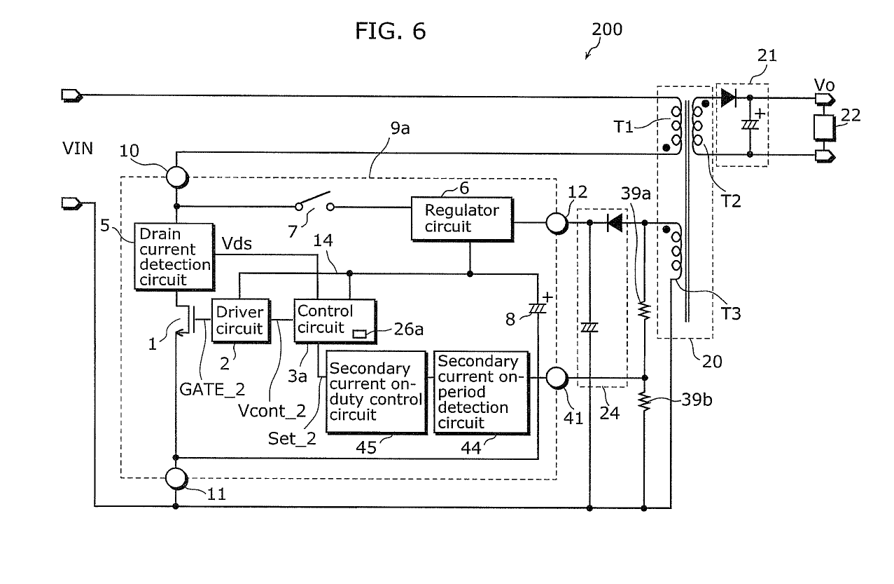

FIG. 6 shows the switching power supply device 200 which includes the switching element driving control circuit 9a according to Embodiment 2 of the present invention.

In FIG. 6, the switching power supply device 200 includes the switching element driving control circuit 9a, a transformer 20, a rectifying and smoothing circuit 21, a load 22, and a rectifying and smoothing circuit 24.

The transformer 20 includes a primary winding T1, a secondary winding T2, and a supplementary winding T3. The switching element driving control circuit 9a includes: a switching element 1 made of a power MOSFET; a driver circuit 2; a control circuit 3a; a drain current detection circuit 5; a regulator circuit 6; a starting current supplying switch 7; a capacitor 8; a circuit power supply line 14; a secondary current on-period detection circuit 44, and a secondary current on-duty control circuit 45. The switching element driving control circuit 9a includes, as external terminals, a DRAIN terminal 10 for supplying a drain current to the switching element 1; a SOURCE terminal 11 for supplying a source current to the switching element 1; a VCC terminal 12 for receiving a high voltage supplied to the regulator circuit 6; a TR terminal 41 for providing a voltage generated at the supplementary winding T3.

The primary winding T1 of the transformer 20 is connected to the DRAIN terminal 10 of the switching element driving control circuit 9a.

The secondary winding T2 of the transformer 20 is connected to the rectifying and smoothing circuit 21. The voltage generated at the secondary winding T2 of the transformer 20 by the switching operation of the switching element 1 is supplied to the load 22 as a stabilized DC voltage.

The supplementary winding T3 of the transformer is connected to the rectifying and smoothing circuit 24, and supplies a voltage as a high voltage input power supply to the VCC terminal 12 of the switching element driving control circuit 9a.

Further, series resistances 39a and 39b connected to the supplementary winding T3 generate division signals of the voltage of the supplementary winding T3 and provides the generated division signals to the TR terminal 41.

In the switching element driving control circuit 9a, the switching element 1 is connected between the DRAIN terminal 10 and the SOURCE terminal 11, and repeats supplying and stopping a current which flows through the primary winding T1, by the switching operation. Further, the drain current detection circuit 5, provided between the switching element 1 and the DRAIN terminal 10, detects an element current which flows through the switching element 1, and outputs an element current detection signal Vds to the control circuit 3a.

The secondary current on-period detection circuit 44 is connected to the TR terminal 41, and detects a first period that is a period from when the switching element 1 turns off till when the secondary current which flows through the secondary winding T2 finishes flowing. More specifically, a fly-back voltage is generated at the supplementary winding T3 due to a mutual induction, after the switching element 1 turns off. After the secondary current finishes flowing, the secondary current on-period detection circuit 44 detects the decrease in the fly-back voltage, and outputs a transformer reset signal for resetting the transformer 20 to the secondary current on-duty control circuit 45.

The secondary current on-duty control circuit 45 sets a period from when the switching element 1 turns off till when a transformer reset signal is generated to a first period (a secondary side on-period), a period during which the secondary current does not flow to a second period (a secondary side off-period), and a period including the first period and the second period to a third period. The secondary current on-duty control circuit 45 outputs an output signal Set_2 that is a clock signal for turning on the switching element 1 such that the on-duty ratio of the first period to the third period can be maintained.

The control circuit 3a is connected to the drain current detection circuit 5, the TR terminal 41, and the secondary current on-duty control circuit 45, and generates a control signal Vcont_2 for controlling the switching operation of the switching element 1.

The driver circuit 2 is connected to a gate terminal that is a control terminal of the switching element 1. The driver circuit 2 converts the control signal Vcont_2 of the control circuit 3a to an output signal GATE_2 that has a current capability suited for the size of the switching element 1, and supplies the switching element 1 with the output signal GATE_2.

The regulator circuit 6 is connected to the VCC terminal 12 that is a high voltage input terminal which receives a voltage generated at the supplementary winding T3 of the transformer 20. The regulator circuit 6 generates a power supply voltage having a voltage amplitude lower than the voltage of the supplementary winding T3 based on the voltage of the supplementary winding T3 of the transformer 20, and supplies the circuit power supply line 14 with the generated voltage. Further, the starting current supplying switch 7 connects the regulator circuit 6 and the DRAIN terminal 10 that is a high voltage terminal connected to the primary winding of the transformer 20, at the time of start-up, or when the voltage of the VCC terminal 12 is lower than the voltage of the circuit power supply line 14. Further, the capacitor 8 is provided for stabilizing the power supply voltage generated by the regulator circuit 6, that is, for smoothing the amplitude of the power supply voltage so that a high frequency component is removed. The smoothed power supply voltage is supplied to the circuit power supply line 14. In such a manner, it is possible that the regulator circuit 6 stably generates the power supply voltage even in the case where the voltage of the supplementary winding T3 is lower than the voltage of the circuit power supply line 14.

Further, the circuit power supply line 14 is connected to the respective circuits mounted on the switching element driving control circuit 9a, such as the driver circuit 2, the control circuit 3a, the secondary current on-period detection circuit 44, and the secondary current on-duty control circuit 45. The respective circuits are driven by the power supply voltage supplied from the circuit power supply line 14.

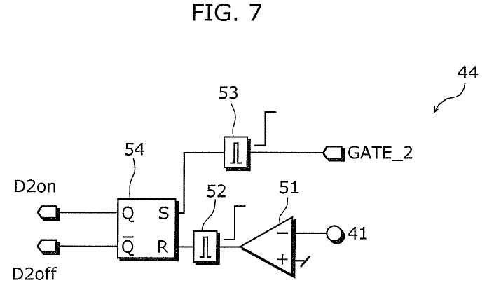

FIG. 7 shows the secondary current on-period detection circuit 44 of the switching element driving control circuit 9a according to Embodiment 2 of the present invention.

In FIG. 7, the secondary current on-period detection circuit 44 includes a comparator 51, pulse generators 52 and 53, and an RS latch circuit 54.

The comparator 51 has one input terminal connected to the TR terminal 41, and another input terminal connected to the reference voltage.

The pulse generators 52 and 53 generate a pulse when the level of respective input signals is changed from High to Low.

The pulse generator 52 is connected to the output of the comparator 51, and outputs a pulse signal to a reset input R of the RS latch circuit 54 when the voltage of the TR terminal 41 is lower than the reference voltage. The pulse generator 53 receives the output signal GATE_2 of the driver circuit 2 as an input, converts the received output signal GATE_2 to a pulse signal, and outputs the resultant to the set input S of the RS latch circuit 54.

As described, the output signal D2_on output from the output Q of the secondary current on-period detection circuit 44 is in high level during a period from when the switching element 1 turns off till the transformer reset signal is detected. The other output signal D2_off is an inversion signal of the output signal D2_on.

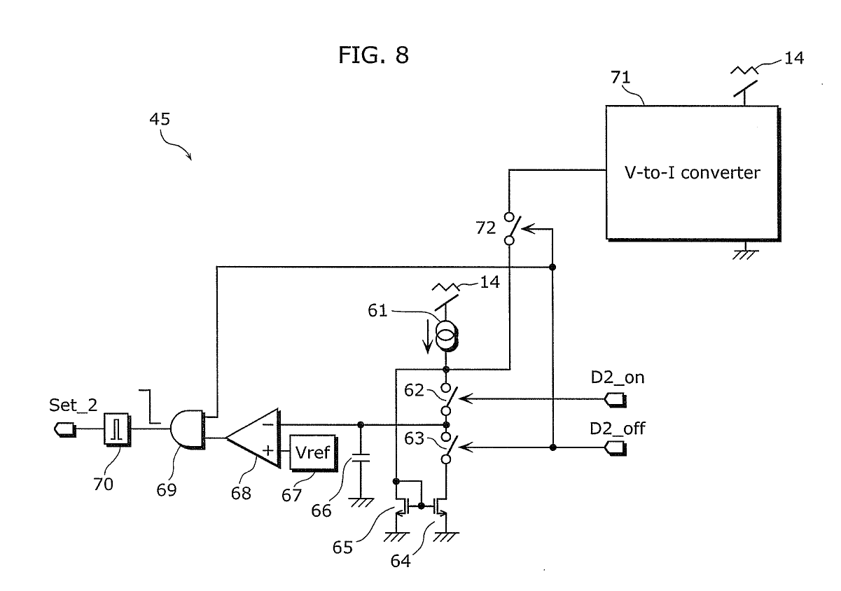

FIG. 8 shows a first configuration example of the secondary current on-duty control circuit 45 of the switching element driving control circuit 9a according to Embodiment 2 of the present invention.

As shown in FIG. 8, the secondary current on-duty control circuit 45 includes a constant current source 61, switches 62 and 63, MOSFETs 64 and 65, a capacitor 66, a reference voltage source 67, a comparator 68, an AND circuit 69, a pulse generator 70, a V-to-I convertor 71, and a switch 72.

The switch 62 is connected to the output signal D2_on of the secondary current on-period detection circuit 44. The switch 63 is connected to the output signal D2_off of the secondary current on-period detection circuit 44. The switches 62 and 63 turn on and off according to the output signals D2_on and D2_off.

The MOSFETs 64 and 65 are connected to form a current mirror. The current of the constant current source 61 is charged and discharged to and from the capacitor 66 via the switches 62 and 63. Here, in addition to the current from the constant current source 61, the current of the V-to-I convertor 71 which voltage-to-current converts the voltage of the circuit power supply line 14 is also added to the charge and discharge current of the capacitor 66.

Further, the V-to-I convertor 71 is connected by the switch 72 only when the signal D2_on is in its High level or when the signal D2_on is in its Low level; and thus, the charging or discharging period of the capacitor 66 varies depending on the oscillation of the voltage of the circuit power supply line 14.

As a result, the ratio of the charging period to the discharging period of the capacitor 66 of the switching element 1, that is, the on-duty ratio of the first period to the third period, is not constant, and the modulation control reflecting the variation of the power supply voltage of the circuit power supply line 14 is performed. More specifically, the output signal input to the comparator 68 from the capacitor 66 is controlled at a frequency having a modulation component according to the oscillation of the power supply voltage even in the case where the load is constant and the secondary side on-period is constant.

The voltage of the capacitor 66 is compared with the reference voltage Vref output from the reference voltage source 67 by the comparator 68.

The AND circuit 69 calculates the output of the comparator 68 and the signal D2_off. The pulse generator 70 generates a pulse signal based on the calculation result.

When the signal D2_on is in its High level, that is, while the current flows at the secondary side of the transformer 20, the capacitor 66 is charged, and when the signal D2_on is in its Low level, that is, while the current does not flow at the secondary side of the transformer 20, the capacitor 66 is discharged.

In the case where the electric potential of the capacitor 66 is equal to the reference voltage Vref of the reference voltage source 67 while the capacitor 66 is being discharged, the pulse generator 70 outputs the output signal Set_2 that is a clock signal serving as a turn-on control pulse.

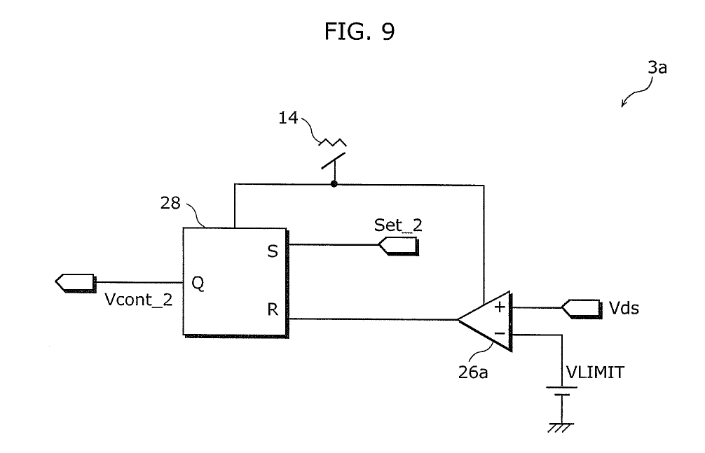

FIG. 9 shows the control circuit 3a of the switching element driving control circuit 9 according to Embodiment 2 of the present invention.

In FIG. 9, the control circuit 3a includes a drain current control circuit 26a, and an RS latch circuit 28 which are connected to the circuit power supply line 14.

The drain current control circuit 26a has, as inputs, an element current detection signal Vds output from the drain current detection circuit 5 and a reference voltage VLIMIT, and when the element current detection signal Vds is equal to the reference voltage VLIMIT, generates a turn-off control pulse for turning off the switching element 1.

The RS latch circuit 28 receives the output signal Set_2 of the secondary current on-duty control circuit 45 through the set input S, receives the output of the drain current control circuit 26a through the reset input R, and outputs, through the output Q, the control signal Vcont_2 for determining the turn-on of the switching element 1.

Through such a control, the switching element 1 is turned on such that the ratio of the charging period to the discharging period of the capacitor 66 is constant.

After that, the control signal Vcont_2 output from the control circuit 3a is input to the driver circuit 2. The driver circuit 2 converts the control signal Vcont_2 to the output signal GATE_2 that has a current capability suited for the size of the switching element 1, and inputs the output signal GATE_2 to the control terminal (gate terminal) of the switching element 1. The voltage generated at the secondary winding T2 of the transformer 20 by the switching operation of the switching element 1 is supplied to the load 22 as a stabilized DC voltage via the rectifying and smoothing circuit 21.

As described, in the switching power supply device 200 according to Embodiment 2 of the present invention, the output signal output from the control circuit 3a is controlled by detecting the secondary side on-period from the TR terminal 41, using the secondary current on-period detection circuit 44, and by the secondary current on-duty control circuit 45 controlling the output signal Set_2 such that the secondary side on-duty ratio, that is, the on-duty ratio of the first period to the third period is constant.

### Variation of Embodiment 2

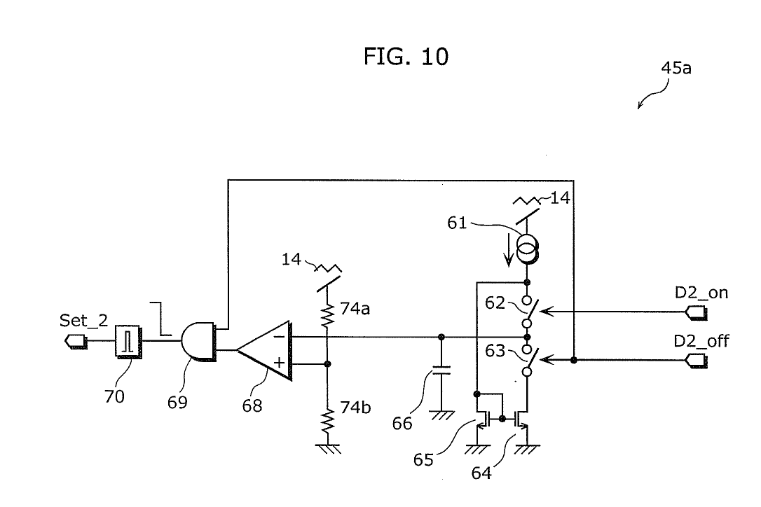

FIG. 10 shows a second configuration example of the secondary current on-duty control circuit of the switching element driving control circuit according to a variation of Embodiment 2 of the present invention. The secondary current on-duty control circuit 45a according to the present variation differs from the secondary current on-duty control circuit 45 in that the secondary current on-duty control circuit 45a includes the series resistances 74a and 74b instead of the reference voltage source 67, and does not include the V-to-I converter 71.

More specifically, in the secondary current on-duty control circuit 45, the constant current source 61 is connected to the V-to-I converter 71 in parallel, so that the charging and discharging current of the capacitor 66 includes, in addition to the current from the constant current source 61, the current output from the V-to-I converter 71 which voltage-to-current converts the power supply voltage of the circuit power supply line 14. In the present variation, the reference voltage input to the comparator 68 varies depending on the oscillation of the power supply voltage due to the series resistances 74a and 74b.

As shown in FIG. 10, the secondary current on-duty control circuit 45a includes the constant current source 61, switches 62 and 63, MOSFETS 64 and 65, the capacitor 66, the series resistances 74a and 74b which resistor-dividing the voltage of the circuit power supply line 14, the comparator 68, the AND circuit 69, and the pulse generator 70.

The switch 62 is connected to the output signal D2_on of the secondary current on-period detection circuit 44. The switch 63 is connected to the output signal D2_off of the secondary current on-period detection circuit 44. The switches 62 and 63 turn on and off according to the output signals D2_on, and D2_off.

The MOSFETs 64 and 65 are connected to have a current mirror. The current of the constant current source 61 is charged to and discharged from the capacitor 66 via the switches 62 and 63.

The series resistances 74a and 74b are connected to one input of the comparator 68. The one input of the comparator 68 receives the voltage corresponding to the resistance divided value of the power supply voltage of the circuit power supply line 14. The other input of the comparator 68 is connected to the capacitor 66. The capacitor 66 is compared with the resistance divided value of the power supply voltage of the circuit power supply line 14 input to the one input of the comparator 68.

The AND circuit 69 calculates the output of the comparator 68 and the signal D2_off. The pulse generator 70 generates a pulse signal based on the calculation result.

When the signal D2_on is in High level, that is, while the current flows at the secondary side of the transformer 20, the capacitor 66 is charged. When the signal D2_on is in Low level, that is, while the current does not flow at the secondary side of the transformer 20, the capacitor 66 is discharged.

In the case where the electric potential of the capacitor 66 is equal to the resistance divided value of the power supply voltage of the circuit power supply line 14 while the capacitor 66 is discharged, the pulse generator 70 outputs the output signal Set_2 that is a clock signal that will serve as a turn-on control pulse.

After that, the output signal Set_2 is input to the set input S of the RS latch circuit 28 of the control circuit 3a, and the control signal Vcont_2 for determining turn-on of the switching element 1 is output from the output Q.

Here, the electric potential of the capacitor 66 is compared not with the constant potential by the comparator 68, but with the varying resistance divided value of the power supply voltage of the circuit power supply line 14. Thus, the secondary side on-duty ratio, that is the on-duty ratio of the first period to the third period is not constant, and the modulation control reflecting the variation of the power supply voltage is performed.

As a result, the secondary side on-duty ratio to the switching cycle of the switching element 1 is not constant, and the modulation control reflecting the variation of the power supply voltage is performed. More specifically, the output signal from the capacitor 66 input to the comparator 68 does not have a constant frequency even when the load is constant and the secondary side on-period is constant, and the output signal is controlled at a frequency having a modulation component according to the oscillation of the power supply voltage.

Through such a control, the switching element 1 is turned on such that the ratio of the charging period to the discharging period of the capacitor 66, that is, the on-duty ratio of the first period to the third period is constant.

In embodiment 2, in FIG. 6, an example is described where the switching power supply device 200 controls only the constant current; however, it may be that the switching power supply device 200 can also control the constant voltage using the output voltage detection circuit 23 or the like similarly to the switching power supply device 100 in FIG. 1 according to Embodiment 1.

Further, for example, part of the control circuit 3a of the switching element driving control circuit 9a, the regulator circuit 6, and the like may be incorporated in a single package. In this case, as shown in FIG. 6, the capacitor 8 for smoothing the power supply voltage can be externally adjusted through the VCC terminal 12 that is an external terminal provided to the switching element driving control circuit 9a. Thus, the modulation component of the secondary side on-duty ratio can be externally set via the capacitor 8.

### Embodiment 3

Next, a switching element driving control circuit 9b and a switching power supply device 300 according to Embodiment 3 of the present invention is described. In the present embodiment, an example of a switching power supply device of a quasi-resonant control method which includes a resonant capacitor 4 in parallel to the switching element 1 is described.

The present embodiment differs from Embodiment 2 in that the switching element driving control circuit 9b includes a turn-on control circuit 73 instead of the secondary current on-duty control circuit 45. Further, the switching element driving control circuit 9b includes the output voltage detection circuit 23 and the FB terminal 13 as in Embodiment 1.

With the configuration, by adding, as a modulation component, the oscillation of the power supply voltage generated by the regulator circuit 6 to the switching frequency of the switching power supply device 300 of the quasi-resonant control method, noises of the switching element driving control circuit 9b can be reduced without adding a low-frequency oscillation circuit.

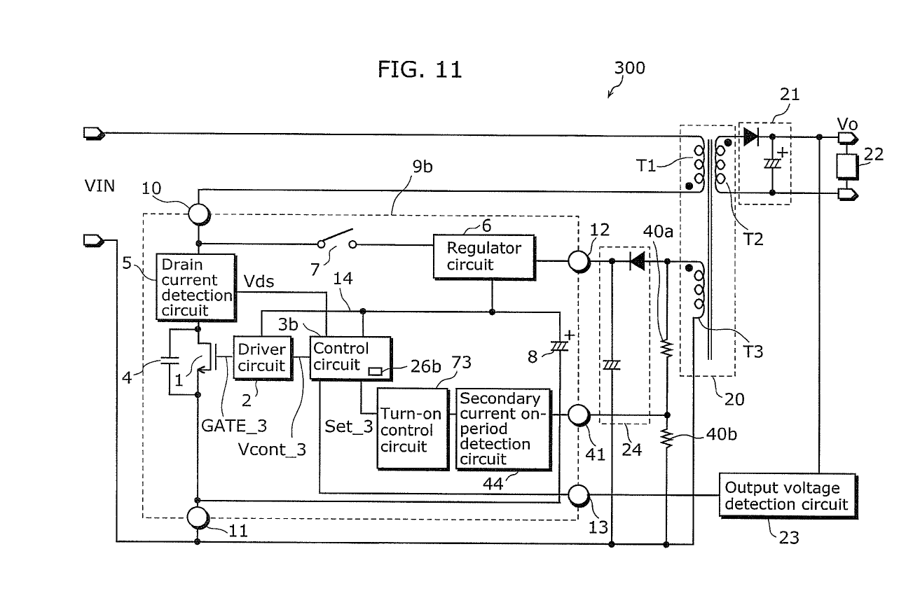

FIG. 11 shows the switching power supply device 300 which includes the switching element driving control circuit 9b according to Embodiment 3 of the present invention.

In FIG. 11, the switching power supply device 300 includes the switching element driving control circuit 9b, a transformer 20, a rectifying and smoothing circuit 21, a load 22, an output voltage detection circuit 23 and a rectifying and smoothing circuit 24.

The transformer 20 includes a primary winding T1, a secondary winding T2, and a supplementary winding T3. The switching element driving control circuit 9b includes: a switching element 1 made of a power MOSFET; a driver circuit 2; a control circuit 3b; a drain current detection circuit 5; a regulator circuit 6; a starting current supplying switch 7; a capacitor 8; a circuit power supply line 14; a resonant capacitor 4, a secondary current on-period detection circuit 44, and a turn-on control circuit 73. The switching element driving control circuit 9b includes, as control terminals, a DRAIN terminal 10 for supplying a drain current to the switching element 1; a SOURCE terminal 11 for supplying a source current; a VCC terminal 12 for receiving a high voltage supplied to the regulator circuit 6; an FB terminal 13 for inputting a feedback voltage to the control circuit 3b; and a TR terminal 41 for receiving a voltage generated at the supplementary winding T3.

The primary winding T1 of the transformer 20 is connected to the DRAIN terminal 10 of the switching element driving control circuit 9b.

The secondary winding T2 of the transformer 20 is connected to the rectifying and smoothing circuit 21. The voltage generated at the secondary winding T2 of the transformer 20 by the switching operation of the switching element 1 is supplied to the load 22 as a stabilized DC voltage. Further, the output of the rectifying and smoothing circuit 21 is connected to the output voltage detection circuit 23 which detects the output voltage output from the rectifying and smoothing circuit 21 as an output signal for feedback. The output voltage detection circuit 23 is connected to the FB terminal 13 of the switching element driving control circuit 9b.

The supplementary winding T3 of the transformer 20 is connected to the rectifying and smoothing circuit 24, and supplies a voltage as a high voltage input power supply to the VCC terminal 12 of the switching element driving control circuit 9b.

Further, the series resistances 40a and 40b connected to the supplementary winding T3 generate division signals of the voltage of the supplementary winding T3 and inputs the generated division signals to the TR terminal 41.

In the switching element driving control circuit 9b, the switching element 1 is connected between the DRAIN terminal 10 and the SOURCE terminal 11, and repeats supplying and stopping a current which flows through the primary winding T1, by the switching operation. Further, the resonant capacitor 4 is connected to the switching element 1 in parallel. The resonant capacitor 4 and the primary winding T1 of the transformer 20 constitute the quasi-resonator. When the switching element 1 is OFF, the resonant capacitor 4 and the primary winding T1 resonate. Further, the drain current detection circuit 5, provided between the switching element 1 and the DRAIN terminal 10, detects an element current which flows through the switching element 1, and outputs an element current detection signal Vds to the control circuit 3b.

The secondary current on-period detection circuit 44 is connected to the TR terminal 41, and detects a first period that is a period from when the switching element 1 turns off till when the secondary current which flows through the secondary winding T2 finishes flowing. More specifically, a fly-back voltage is generated at the supplementary winding T3 due to a mutual induction after the switching element 1 turns off. After the secondary side current finishes flowing, the secondary current on-period detection circuit 44 detects the decrease in the fly-back voltage, and generates a transformer reset signal for resetting the transformer 20. The turn-on control circuit 73 converts the transformer reset signal to a pulse signal and generates an on-signal Set_3 that is a turn-on control pulse for turning on the switching element 1.

The control circuit 3b is connected to the drain current detection circuit 5, the FB terminal 13, and the turn-on control circuit 73, and generates a control signal Vcont_3 for controlling the switching operation of the switching element 1.

The driver circuit 2 is connected to a gate terminal that is a control terminal of the switching element 1. The driver circuit 2 converts the control signal Vcont_3 of the control circuit 3b to an output signal GATE_3 that has a current capability suited for the size of the switching element 1, and supplies the switching element 1 with the output signal GATE_3.

The regulator circuit 6 is connected to the VCC terminal 12 that is a high voltage input power supply which receives a voltage generated at the supplementary winding T3 of the transformer 20. The regulator circuit 6 generates a power supply voltage having a voltage amplitude lower than the voltage of the supplementary winding T3 based on the voltage of the supplementary winding T3 of the transformer 20, and supplies the circuit power supply line 14 with the generated power supply voltage. Further, the starting current supplying switch 7 connects the regulator circuit 6 and the DRAIN terminal 10 that is a high voltage terminal connected to the primary winding of the transformer 20, at the time of start-up, or when the voltage of the VCC terminal 12 is lower than the voltage of the circuit power supply line 14. Further, the capacitor 8 is provided for stabilizing the power supply voltage generated by the regulator circuit 6, that is, for smoothing the amplitude of the power supply voltage so that a high frequency component is removed. The smoothed power supply voltage is supplied to the circuit power supply line 14.

By doing so, even when the voltage of the supplementary winding T3 is lower than the voltage of the circuit power supply line 14, the regulator circuit 6 can stably generate the voltage of the circuit power supply line 14.

Further, the circuit power supply line 14 is connected to respective circuits mounted on the switching element driving control circuit 9b, such as the driver circuit 2, the control circuit 3b, the secondary current on-period detection circuit 44, and the turn-on control circuit 73. The respective circuits are driven by the power supply voltage supplied from the circuit power supply line 14.

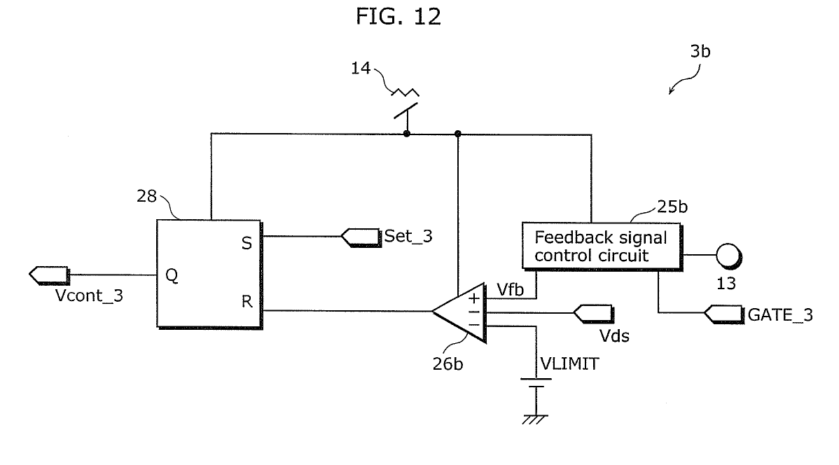

FIG. 12 is a first configuration example of the control circuit 3b of the switching element driving control circuit 9b according to Embodiment 3 of the present invention.

In FIG. 12, the control circuit 3b includes a feedback signal control circuit 25b, the drain current control circuit 26b, and the RS latch circuit 28. The respective circuit 25b, 26b and 28 are connected to the circuit power supply line 14.

The feedback signal control circuit 25b is connected to the FB terminal 13. The feedback signal control circuit 25b amplifies the feedback output signal that is output from the output voltage detection circuit 23 and provided to the FB terminal 13, filters the amplified signal, outputs the feedback control signal Vfb, and inputs the resultant to the drain current control circuit 26b. The output signal GATE_3 output from the driver circuit 2 may also be input to the feedback signal control circuit 25b for feedback.

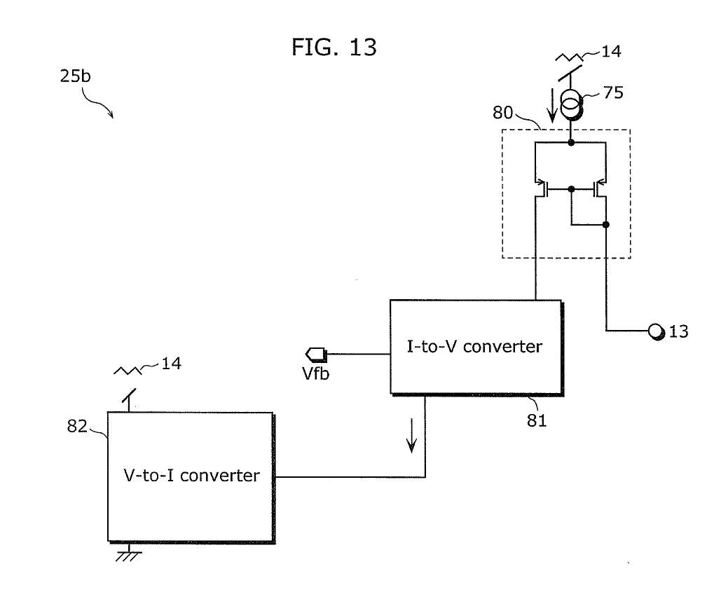

FIG. 13 is a configuration example of the feedback signal control circuit 25b. In FIG. 13, the feedback signal control circuit 25b includes a constant current source 75, a mirror circuit 80, an I-to-V convertor 81, and a V-to-I convertor 82.

The mirror circuit 80 is connected to the FB terminal 13. The mirror circuit 80 receives the output signal from the output voltage detection circuit 23 as a current signal, amplifies the received signal, and outputs the amplified signal to the I-to-V convertor 81. Further, the V-to-I convertor 82 is connected to the I-to-V convertor 81. The V-to-I convertor 82 resistance-divides the power supply voltage of the circuit power supply line 14, converts the resultant from the voltage to the current, and superimposes the modulation component of the current signal corresponding to the power supply voltage of the circuit power supply line 14 on the output signal received by the I-to-V convertor 81 from the mirror circuit 80. The I-to-V convertor 81 converts the output signal received from the mirror circuit 80 and the V-to-I convertor 82 from the current to the voltage, and generates a feedback control signal Vfb. More specifically, the feedback control signal Vfb varies depending on the oscillation of the power supply voltage.

The feedback control signal Vfb is input to the drain current control circuit 26b.

Further, as shown in FIG. 12, the drain current control circuit 26b receives, as inputs, an element current detection signal Vds output from the drain current detection circuit 5 and a reference voltage VLIMIT, and outputs a turn-off control pulse of the switching element 1 when the element current detection signal Vds is equal to the reference voltage VLIMIT or the feedback control signal Vfb. More specifically, the drain current control circuit 26b generates an off-signal for turning off the switching element 1 when the current that flows through the switching element 1 reaches the current peak level of the switching element that is set according to the feedback control signal Vfb.

Here, the feedback control signal Vfb includes the modulation component added according to the oscillation of the power supply voltage of the circuit power supply line 14; and thus, the current peak level of the switching element is also modulated according to the oscillation of the power supply voltage. Further, the drain current control circuit 26b is connected to the circuit power supply line 14; and thus, the current peak level of the switching element is modulated according to the oscillation of the power supply voltage.

Further, in FIG. 12, the RS latch circuit 28 receives the on-signal Set_3 output from the turn-on control circuit 73 through the set input S, receives the off-signal output from the drain current control circuit 26b through the reset input R, and outputs the control signal Vcont_3 through the output Q.

After that, the control signal Vcont_3 output from the control circuit 3 is input to the driver circuit 2. The driver circuit 2 converts the control signal Vcont_3 to the output signal GATE_3 that has a current capability suited for the size of the switching element 1, and inputs the output signal GATE_3 to the control terminal (gate terminal) of the switching element 1. The voltage generated at the secondary winding T2 of the transformer 20 by the switching operation of the switching element 1 is supplied to the load 22 as a stabilized DC voltage via the rectifying and smoothing circuit 21.

In such a manner, in the switching power supply device 300 of the quasi-resonant control method according to Embodiment 3 of the present invention, the switching element 1 is turned on according to the on-signal Set_3 generated according to the transformer reset signal generated by the secondary current on-period detection circuit 44, and the switching element 1 is turned off according to an off-signal generated according to the feedback control signal Vfb. Here, the feedback control signal Vbf is modulated according to the oscillation of the power supply voltage of the circuit power supply line 14, and the modulation component according to the power supply voltage is added to the current peak level of the switching element. As a result, by the switching operation of the switching element 1, the frequency of the resonant operation of the quasi-resonator which includes the resonant capacitor 4 connected in parallel with the switching element 1 and the primary winding T1 of the transformer 20 is also modulated according to the oscillation of the power supply voltage.

### Variation of Embodiment 3

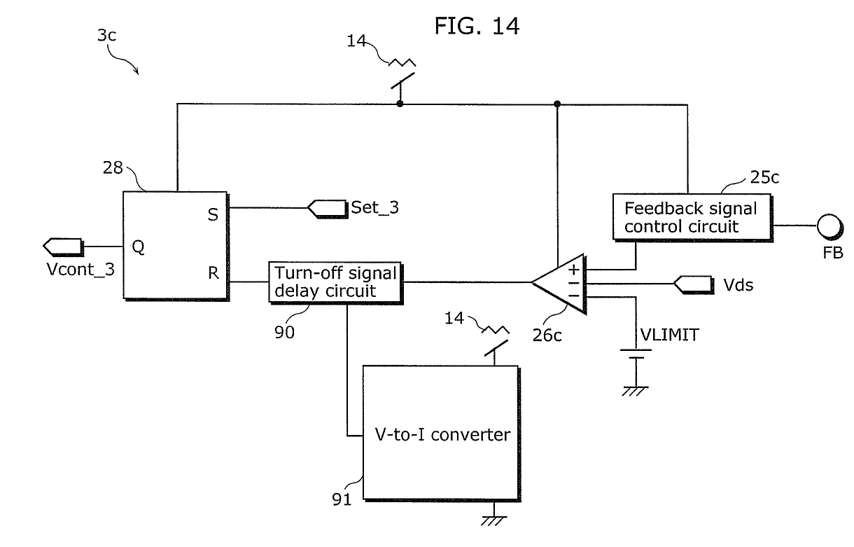

FIG. 14 shows a second configuration example of the control circuit of the switching element driving control circuit according to a variation of Embodiment 3 of the present invention. The control circuit 3c according to the present variation differs from the control circuit 3b in that the control circuit 3c includes a turn-off signal delay circuit 90 and a V-to-I convertor 91.

More specifically, in the configuration where the control circuit 3b is included, the feedback control signal Vfb is modulated according to the oscillation of the power supply voltage of the circuit power supply line 14; however, in the present variation, the turn-off delay time is modulated according to the oscillation of the power supply voltage.

As shown in FIG. 14, the control circuit 3c includes a feedback signal control circuit 25c, a drain current control circuit 26c, an RS latch circuit 28, a turn-off signal delay circuit 90, and a V-to-I convertor 91.

The feedback signal control circuit 25c is connected to the FB terminal 13. The feedback signal control circuit 25c amplifies an output signal output from the output voltage detection circuit 23, filters the amplified signal, generates a feedback control signal Vfb, and outputs the resultant to the drain current control circuit 26c. Further, the drain current control circuit 26c receives, as inputs, the element current detection signal Vds and the reference voltage VLMIT, and generates a turn-off control pulse of the switching element 1 when the element current detection signal Vds is equal to the reference voltage VLIMIT or the feedback control signal Vfb.

The turn-off signal delay circuit 90 is connected to the drain current control circuit 26c. The turn-off signal delay circuit 90 adds a delay time to a turn-off control pulse generated by the drain current control circuit 26c, and inputs a delayed turn-off control pulse to the reset input R of the RS latch circuit 28.

Here, the turn-off signal delay circuit 90 is connected to the V-to-I convertor 91 which resistance-divides the power supply voltage of the circuit power supply line 14 and converts from voltage to current. Thus, the delay time of the turn-off signal delay circuit 90 varies depending on the oscillation of the power supply voltage, and the turn-off control pulse varies depending on the oscillation of the power supply voltage. The modulation component is added to the current peak level of the switching element 1 according to the oscillation of the power supply voltage. As a result, by the switching operation of the switching element 1, the frequency of the resonant operation of the quasi-resonator including the resonant capacitor 4 connected in parallel to the switching element 1 and the primary winding T1 of the transformer 20 is also modulated according to the oscillation of the power supply voltage.

In Embodiment 3, for example, in the case where part of the is control circuit 3b or 3c of the switching element driving control circuit 9b is incorporated into a same package, the capacitor 8 for smoothing the power supply voltage can be externally adjusted from the VCC terminal 12 that is an external terminal provided to the switching element driving control circuit 9b as shown in FIG. 11. Thus, the modulation component of the on-signal and off-signal can be externally set via the capacitor 8.

The present invention is not limited to the embodiments described above, but various changes and modification may be made within the scope of the invention.

For example, in the Embodiments, the VCC terminal 12 is connected to the supplementary winding T3 via the rectifying and smoothing circuit 24, and the voltage generated at the supplementary winding T3 of the transformer 20 is supplied to the regulator 6. However, it may be that the oscillation of the power supply voltage generated by the regulator circuit 6 is further stabilized by opening the VCC terminal 12 or by connecting the capacitor to the VCC terminal 12. In such a case, it may be that the regulator circuit 6 always generates the power supply voltage with the DRAIN terminal 10 as an input.

Further, the present invention may be applied to a switching power supply device employing any methods including the PWM control method, the PFM control method, the secondary current on-duty control method, the quasi-resonant control method.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The switching element driving control circuit and the switching power supply device according to the present invention can reduce the size and cost of the switching power supply while reducing noises without providing a noise proof component such as a filter circuit. They are useful as a motor control circuit, lighting, and a switching power supply.

What is claimed is:

1. A switching element driving control circuit included in a switching power supply device which includes a transformer having a primary winding and a secondary winding and which converts an input voltage into a desired DC voltage, said switching element driving control circuit controlling a switching operation of a switching element which repeats supplying and stopping a current that flows through the primary winding, said switching element driving control circuit comprising:
a regulator circuit which generates a power supply voltage having an amplitude;
a capacitor which smoothes the power supply voltage generated by said regulator circuit to remove a high frequency component;
a circuit power supply line to which the smoothed power supply voltage is supplied;
an oscillation circuit which generates a periodic signal according to an oscillation of the power supply voltage supplied from said circuit power supply line;
a control circuit which generates a control signal for controlling the switching operation of the switching element, based on the periodic signal; and
a driver circuit which supplies the switching element with the control signal.

2. A switching element driving control circuit included in a switching power supply device which includes a transformer having a primary winding and a secondary winding and which converts an input voltage into a desired DC voltage, said switching element driving control circuit controlling a switching operation of a switching element which repeats supplying and stopping a current that flows through the primary winding, said switching element driving control circuit comprising:
a regulator circuit which generates a power supply voltage having an amplitude;
a capacitor which smoothes the power supply voltage generated by said regulator circuit to remove a high frequency component;
a circuit power supply line to which the smoothed power supply voltage is supplied;
a secondary current on-period detection circuit which detects a first period that is a period from when the switching element turns off until when a secondary current that flows through the secondary winding finishes flowing;
a secondary current on-duty control circuit which generates a clock signal according to the amplitude of the power supply voltage supplied from said circuit power supply line such that an on-duty ratio of the first period to a third period is maintained, the clock signal turning on the switching element, the third period including the first period and a second period that is a period during which the secondary current does not flow;
a control circuit which generates a control signal for controlling the switching operation of the switching element, based on the clock signal; and
a driver circuit which supplies the switching element with the control signal.

3. A switching element driving control circuit included in a switching power supply device which includes a transformer having a primary winding and a secondary winding and which converts an input voltage into a desired DC voltage, said switching element driving control circuit controlling a switching operation of a switching element which repeats supplying and stopping a current that flows through the primary winding, said switching element driving control circuit comprising:
a regulator circuit which generates a power supply voltage having an amplitude;
a capacitor which smoothes the power supply voltage generated by said regulator circuit to remove a high frequency component;
a circuit power supply line to which the smoothed power supply voltage is supplied;
a secondary current on-period detection circuit which detects a first period that is a period from when the switching element turns off until when a secondary current that flows through the secondary winding finishes flowing;
a turn-on control circuit which generates an on-signal for turning on the switching element, according to an output of said secondary current on-period detection circuit;
a control circuit which includes a drain current control circuit that generates an off-signal according to the amplitude of the power supply voltage supplied from said circuit power supply line when a current that flows through the switching element reaches a predetermined current peak level, the off-signal turning off the switching element, said control circuit generating a control signal for controlling the switching operation of the switching element, based on the on-signal and the off-signal; and
a driver circuit which supplies the switching element with the control signal.

4. The switching element driving control circuit according to claim 1,
wherein said regulator circuit is a hysteresis control regulator circuit which controls an output voltage based on a first threshold and a second threshold lower than the first threshold.

5. The switching element driving control circuit according to claim 2,
wherein said regulator circuit is a hysteresis control regulator circuit which controls an output voltage based on a first threshold and a second threshold lower than the first threshold.

6. The switching element driving control circuit according to claim 3,
wherein said regulator circuit is a hysteresis control regulator circuit which controls an output voltage based on a first threshold and a second threshold lower than the first threshold.

7. The switching element driving control circuit according to claim 1,
wherein at least said regulator circuit, said control circuit, and said oscillation circuit are incorporated into a single package.

8. The switching element driving control circuit according to claim 2,
wherein at least said regulator circuit, said control circuit, said secondary current on-duty control circuit, and said secondary current on-period detection circuit are incorporated into a signal package.

9. The switching element driving control circuit according to claim 3,
wherein at least said regulator circuit, said control circuit, and said secondary current on-duty control circuit are incorporated into a single package.

10. The switching element driving control circuit according to claim 7, further comprising an external terminal which allows the capacitor to be adjusted.

11. The switching element driving control circuit according to claim 8, further comprising an external terminal which allows the capacitor to be adjusted.

12. The switching element driving control circuit according to claim 9, further comprising an external terminal which allows the capacitor to be adjusted.

13. A switching power supply device comprising:
said switching element driving control circuit according to claim 1; and
a rectifying and smoothing circuit which converts a voltage generated at the secondary winding by the switching operation of the switching element into a DC voltage.

14. A switching power supply device comprising:
said switching element driving control circuit according to claim 2; and
a rectifying and smoothing circuit which converts a voltage generated at the secondary winding by the switching operation of the switching element into a DC voltage.

15. A switching power supply device comprising:
said switching element driving control circuit according to claim 3;
a rectifying and smoothing circuit which converts a voltage generated at the secondary winding by the switching operation of the switching element into a DC voltage.

16. A switching power supply device comprising:
said switching element driving control circuit according to claim 3;
a rectifying and smoothing circuit which converts a voltage generated at the secondary winding by the switching operation of the switching element into a DC voltage; and
an output voltage detection circuit which detects the DC voltage and supplies said control circuit with a feedback signal generated according to a change in the detected DC current,
wherein said drain current control circuit generates the off-signal for turning off the switching element when the current that flows through the switching element reaches the current peak level set according to the feedback signal.
